(19) United States
(12) Patent Application Publication
(10) Pub. No.: US 2025/0061526 A1
(43) Pub. Date: Feb. 20, 2025

(54) Intelligent Legal Document Generation and Review System with Attorney Feedback Loop

(71) Applicant: Alexander Davis, Oxnard, CA (US)

(72) Inventor: Alexander Davis, Oxnard, CA (US)

(21) Appl. No.: 18/806,629

(22) Filed: Aug. 15, 2024

Related U.S. Application Data
(60) Provisional application No. 63/533,329, filed on Aug. 17, 2023.

(51) Int. Cl. G06Q 50/12; G06Q 10/101

(52) U.S. Cl. CPC G06Q 50/12; G06Q 10/101

(57) ABSTRACT

An intelligent legal document generation and review system and associated methods are disclosed. The system comprises one or more processors coupled to memory storing instructions to provide a user interface for receiving user input, execute a natural language processing subsystem to extract relevant information, access a legal rules database, store document templates, and execute an AI algorithm. The AI algorithm retrieves a relevant template based on user input and extracted information, populates the template to generate a customized legal document, and stores the document. An attorney feedback loop allows attorneys to provide feedback that the AI algorithm learns from to improve document generation. The AI algorithm collaborates with attorneys to revise and finalize documents based on the feedback. The system streamlines document preparation, automates complex tasks, and provides expert guidance to help users adhere to legal requirements across jurisdictions.

### BACKGROUND OF THE INVENTION

### Field of Invention

The various aspects discussed herein relate generally to the field of legal document generation and review systems.

### Description of Related Art

Legal document preparation, such as for probate proceedings, is known to be a complex and time-consuming process. Existing methods of handling legal documents suffer from several limitations. Ensuring compliance with varied and intricate legal rules and regulations across jurisdictions is an immense challenge for individuals lacking legal expertise. The multitude of documents involved, such as wills, trusts, and court filings, present difficulties in efficient organization and retrieval. Risks of human error in complex legal procedures are high, potentially leading to costly delays and disputes. Furthermore, barriers in access to affordable legal services and expertise exist.

While some document generation systems are known in the field, they exhibit deficiencies in providing comprehensive solutions to the aforementioned problems. Existing options often lack the accuracy and domain knowledge required to navigate the complexities of legal frameworks that vary across jurisdictions.

Accordingly, there is a need in the art for an intelligent legal document generation and review system that harnesses artificial intelligence in combination with attorney review to produce high-quality, compliant legal documents. Such a system should streamline document management, automate tasks, and provide accessible, real-time legal guidance to assist individuals in understanding and adhering to specific requirements and procedures across different legal domains and jurisdictions.

### BRIEF SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

The present invention relates to an intelligent legal document generation and review system and associated methods that harness artificial intelligence in combination with attorney review to efficiently produce high-quality, legally compliant documents across various jurisdictions.

In one aspect, the system comprises: one or more processors coupled to a memory storing instructions that cause the processor(s) to provide a user interface for receiving user input data related to a legal matter; execute a natural language processing subsystem to extract relevant information; access a legal rules and regulations database; store predefined templates of legal documents; and execute an AI algorithm. The AI algorithm retrieves a relevant template based on the user input and extracted information, populates the template to generate a customized legal document, and stores the document in a repository. A retrieval interface enables users to access their documents. An attorney feedback loop allows attorneys to provide feedback that the AI algorithm learns from to improve document generation. The AI algorithm collaborates with attorneys to revise and finalize documents based on the feedback.

In some embodiments, the AI algorithm is trained on datasets related to laws, cases, regulations and document templates for a specific legal domain such as probate. The user interface may include file upload tools, user authentication, guidance features explaining legal terminology, and integration with external platforms. The natural language processing subsystem analyzes user input to extract key details and identify applicable laws and regulations. Generated documents are securely stored and accessed through local or cloud databases with encryption.

Advantageously, the intelligent legal document generation and review system streamlines document preparation and management, automates complex tasks, and provides expert guidance to help users understand and adhere to specific legal requirements across jurisdictions. By combining AI efficiency with attorney oversight, the system produces superior quality legal documents compared to traditional methods. The collaborative feedback loop allows the AI to continuously improve based on attorney input. The system thus solves the problems of navigating complex legal frameworks, risk of human errors, and barriers in access to affordable legal services that are common in the art.

The foregoing and other features and advantages of the invention will be apparent from the following more particular description of preferred embodiments of the invention, as illustrated in the accompanying drawings.

Additional features and advantages of the invention will be set forth in the description which follows. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a system block diagram illustrating an intelligent legal document generation and review system, according to one embodiment.

FIG. 2 illustrates the user interface of the intelligent legal document generation and review system, according to one embodiment.

FIG. 3 illustrates a flow diagram depicting the steps involved in using the intelligent legal document generation and review system, according to one embodiment.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention provide an intelligent legal document generation and review system that combines AI with legal review in order to generate highly accurate and legally-sound legal documents. In some embodiments, the intelligent legal document generation and review system combines AI with generation and legal review of probate documents in connection with a legal framework associated with probate rules and regulations in a particular jurisdiction. In some embodiments, the intelligent legal document generation and review system surpass traditional probate document generation systems by harnessing the power of AI to produce highly accurate and customized legal documents, which are then enhanced by attorney review, ensuring superior quality, efficiency, and expert guidance throughout the probate process. In some embodiments, the intelligent legal document generation and review system is adapted to apply to other areas of legal documentation with detailed and difficult legal frameworks that differ from one jurisdiction to the next.

Embodiments of the intelligent legal document generation and review system described in this specification provides a solution that improves on the difficult, time-consuming, and error-prone probate process for individuals. Specifically, the intelligent legal document generation and review system provides AI-generated legal documents by way of a backbone AI system with a model trained on datasets related to probate laws, probate cases, probate examples, individual state probate regulations, and other legal document templates. In some embodiments, the backbone AI system leverages natural language processing (NLP) algorithms to analyze user input, extract relevant information, and generate customized legal documents required for the probate process. Additionally, the intelligent legal document generation and review system enables direct user interaction through an intuitive and user-friendly interface that allows individuals involved in the probate process to interact with the AI system. Users would provide necessary information (or prompt information), such as the deceased person's details, beneficiaries, assets, and other relevant data through the interface. Then, the intelligent legal document generation and

review system performs document generation based on the user-provided information. Specifically, the backbone AI system generates the required legal documents based on all such user-provided information to enable the user to go through the probate process. Those documents include any or all of the probate documents that may be needed, such as petitions, inventories, accounting documents, or other relevant forms. The documents would be generated in a customized manner according to the user-provided information. That is, the needed probate documents are customized by the AI system using its training-based knowledge of probate laws and document templates to generate accurate and tailored documents that relate to the user-provided information. In other words, the AI system does not merely output generic forms and documents needed for probate, but customizes names, dates, accounts, listings, etc., in those documents.

After document generation/output, intelligent legal document generation and review system of some embodiments provides the generated probate documents to attorneys for review. Specifically, after the AI system generates the legal documents, they would be provided to attorneys for review. The reviewing attorneys would examine the documents to ensure accuracy, compliance with applicable laws, and may provide legal advice or modifications. In some embodiments, the intelligent legal document generation and review system employs a collaboration and feedback loop through a collaborative system where attorneys can provide feedback on the AI-generated documents. This feedback can be used to continuously train and improve the AI system, enhancing its accuracy and effectiveness over time. Attorneys' expertise and insights can be incorporated into the training process, allowing the AI system to better understand and address complex legal nuances.

In some embodiments, the intelligent legal document generation and review system provides user support and assistance. That is, the user is offered support services and guidance throughout the probate process while engaging with the AI system. For instance, the AI system may provide explanations of legal terms, offer access to resources, assist with any questions or concerns that may arise during document generation or the probate process, or any other guidance or support.

In some embodiments, the intelligent legal document generation and review system provides user support and assistance. That is, the user is offered support services and guidance throughout the probate process while engaging with the AI system. For instance, the AI system may provide explanations of legal terms, offer access to resources, assist with any questions or concerns that may arise during document generation or the probate process, or any other guidance or support.

The intelligent legal document generation and review system of the present disclosure may be comprised of the following elements. This list of possible constituent elements is intended to be exemplary only and it is not intended that this list be used to limit the system to just these elements.

1. AI Algorithm: A trained artificial intelligence algorithm, implemented as a software process, which is capable of NLP and generating legal documents.

2. User Interface (UI): An intuitive, software-implemented interface through which users can interact with the probate AI system. The UI of the intelligent legal document generation and review system includes a graphical user interface (GUI) and graphical user interfaces tools for users of the system to interact and engage in the probate process.

3. Data Input: Mechanism or process for users to input relevant probate-related information. For instance, an input prompt for free-text input, a set of file and information upload graphical user interface tools, etc.

4. Natural Language Processing (NLP): Techniques and algorithms to analyze and understand user-provided data and extract essential details.

5. Probate Laws and Regulations Database: A comprehensive database storing information about relevant probate laws and regulations (in every jurisdiction/state since different jurisdictions/states typically have their own individual probate laws and regulations).

6. Document Templates: Predefined templates of various legal documents required for the probate process.

7. AI Document Generation: The process, implemented in software, by which the AI algorithm generates customized legal documents based on user input and the document templates.

8. Document Repository: A storage system or database to securely store generated legal documents. This may be a local database management system associated with each individual user interacting with the system, a cloud database associated with the user, or a common cloud database with encryption and permissions-based access rights the limits access to generated documents to only the user who prompted the system to generate the documents. (Notably, all data input, data transferring, and/or data storage incorporates data encryption at some level to ensure data privacy and compliance with any legal and ethical considerations.)

9. Document Retrieval: graphical user interface tools or other mechanisms for retrieving and accessing previously generated legal documents (this may trigger user credentials/user authentication system to validate user identity associated with particular legal documents requested for retrieval)

10. Attorney Review Process: Procedures for transferring the generated legal documents to attorneys for review and guidance. The procedures may be automated when implemented in software. The procedures may instead (or also) be informal.

11. Attorney Feedback Loop System: software-implemented process by which attorneys can interact with the users to provide feedback on the AI-generated documents and which also provides a mechanism for continuous improvement of the AI system.

12. Document Revision and Finalization via Collaborative Process: The collaborative process occurs between the AI system and attorneys to make necessary revisions, updates, and finalization of the legal documents. The collaborative process is partly automatic and partly manual. That is, the collaborative process is partly automatic by the AI system retraining, updating templates, etc., based on attorney feedback. On the other hand, the collaborative process is partly manual based on the attorney revisions, etc.

13. Document Delivery System: Software-implemented methods/processes, user interface/output mechanisms, or systems to deliver the finalized legal documents to the users or other relevant parties.

The various elements of the intelligent legal document generation and review system of the present disclosure may be related in the following exemplary fashion. It is not intended to limit the scope or nature of the relationships between the various elements and the following examples are presented as illustrative examples only. The UI and GUI (Item #2) serves as the interaction point between the user and the probate AI system. The data input mechanism (Item #3) is software-implemented and accessible through the UI/GUI to allow users to input relevant probate-related information through the UI (e.g., enter text information at a prompt). The NLP system (Item #4) is integrated into the AI system to analyze and understand the user-provided data and extract essential details. The trained AI algorithm (Item #1) utilizes the processed data and interacts with the probate laws and regulations database (Item #5) to generate customized legal documents based on predefined document templates (Item #6). The generated legal documents are stored in a document repository (Item #8) for secure storage and easy retrieval using a document retrieval GUI tools or other mechanism (Item #9). Users can configure and set their own document repository (Item #8), such as their exclusive cloud database or a local database management system, or select a common cloud database for the document repository (Item #8). Once the documents are generated, they are transferred according to procedures to attorneys for review and guidance, during the attorney review process (Item #10). In connection with the attorney review process (Item #10), attorneys provide feedback on the AI-generated documents, creating a feedback loop known as the attorney feedback loop (Item #11). The AI system and attorneys collaborate on document revision and finalization (Item #12) to make necessary revisions, updates, and finalize the legal documents. The legal documents are then delivered to the users or relevant parties using the document delivery system (Item #13).

The intelligent legal document generation and review system of the present disclosure generally works through the UI/GUI of the software-implementation of the AI system, whereby a user interacts to provide relevant probate-based information for processing by the AI system. The AI system triggers NLP to parse the user-provided information (in natural language, alpha-numeric text format) and extract essential details. To structure and analyze the information effectively, the NLP system may perform text parsing, entity recognition, and sentiment analysis to understand the intent and context of the input. The AI system accesses the probate laws and regulations database to retrieve comprehensive information about probate laws, regulations, and legal requirements, as needed for document generation and compliance checks. The AI algorithm, equipped with the processed data and knowledge of probate laws, generates customized legal documents based on predefined templates which are populated with the information extracted by the NLP system and ensures accuracy, completeness, and adherence to legal requirements. Then the generated legal documents are transferred to attorneys for review and guidance to ensure accuracy, compliance with applicable laws, and provide any necessary modifications or legal advice. Attorneys also provide feedback on the AI-generated documents, creating the feedback loop between the AI system and legal professionals. As a collaborative process, the AI system is able to continually improve, refine, and revise the document generation process. Also through collaboration, the AI system and attorneys work together to make necessary revisions, updates, and finalize the legal documents, thereby ensuring that the documents are accurate, legally compliant, and meet the specific requirements of each probate case. Document delivery occurs after the documents are finalized. Those finalized documents are then delivered to users or relevant parties through appropriate channels, ensuring secure and timely access to the completed documents. In this way, the intelligent legal document generation and review system streamlines the document generation process, reduces errors, ensures legal compliance, and enhances efficiency.

Notably, the document generation logic is implemented in software to generate customized legal documents based on the input data and applicable probate laws. Specifically, the document generation logic determines how the AI system selects the appropriate document templates, populates them with relevant information, and ensures accuracy and completeness. This can be done in a variety of different ways. By way of example, the software-implementation of the document generation logic can be based on AI algorithms which use some of the following techniques: template matching, rule-based systems, machine learning, etc.

The attorney review logic includes procedures and instructions (software-implemented and human readable) defining the workflow and rules for transferring the generated legal documents to attorneys for review and guidance. The logic may also incorporate procedures/instructions for tracking document status, routing documents to specific attorneys, and enabling communication between the AI system and attorneys. Similarly, the document revision and finalization logic is intended to facilitate collaboration between the AI system and attorneys during the document review process. Therefore, implementation of the document revision and finalization process may be a software-implementation or a particular machine-implementation that includes automated process features such as version control (check-in, check-out, access rights, etc.), document comparison, commenting systems, and revision tracking to ensure effective collaboration and finalization of the documents. The document delivery logic is optionally implemented in software as an automatic delivery mechanism or implemented as a manual procedure for document delivery. The underlying logic determines how the finalized documents are delivered to users or relevant parties which may involve generating downloadable file formats, sending documents via secure channels, or integrating with other systems.

In some embodiments, the intelligent legal document generation and review system further comprises one or more machine learning (ML) algorithms implemented in software and configured to train and retrain the model used by the AI algorithm for the AI system. In some embodiments, the ML algorithm analyzes user feedback and attorney feedback to refine the document generation process and learn new legal aspects as they arise. In some embodiments, the intelligent legal document generation and review system further comprises an analytics and reporting engine that is configured to provide analytical data analysis of AI system capabilities to gather insights on system performance, usage patterns, and user satisfaction to drive continuous improvement. In some embodiments, the intelligent legal document generation and review system integrates with one or more electronic filing system to streamline the submission of generated documents to relevant probate courts or other entities. Also, the AI algorithm of the intelligent legal document generation and review system may be one of several different AI algorithms employed to perform the natural language processing (when the NLP system is also integrated) and document generation tasks, offering alternative approaches to achieve similar outcomes. Furthermore, the AI document generation sub-system of some embodiments incorporates several different or alternative document generation methods other than a single process of relying only on the predefined templates. For instance, the different/alternative document generation methods may carry out procedures of rule-based systems, machine learning models, or other techniques to dynamically generate legal documents based on user input and legal requirements. In some embodiments, the intelligent legal document generation and review system is further integrated with third-party systems, external services, or databases. For instance, integrations with legal research platforms, online filing systems, or document management tools, to enhance functionality and improve the user experience.

In some embodiments, the intelligent legal document generation and review system is designed according to a monolithic design architecture. In some embodiments, the intelligent legal document generation and review system is designed according to a modular and customizable design architecture. In the modular architecture, users could select and configure specific features, preferences, or integrations based on their unique needs and requirements. For example, users could select their own local database for storage of the generated documents. In some embodiments, the intelligent legal document generation and review system enhances collaboration via advanced collaboration features such as real-time communication, simultaneous document editing, or the ability to track changes and annotations.

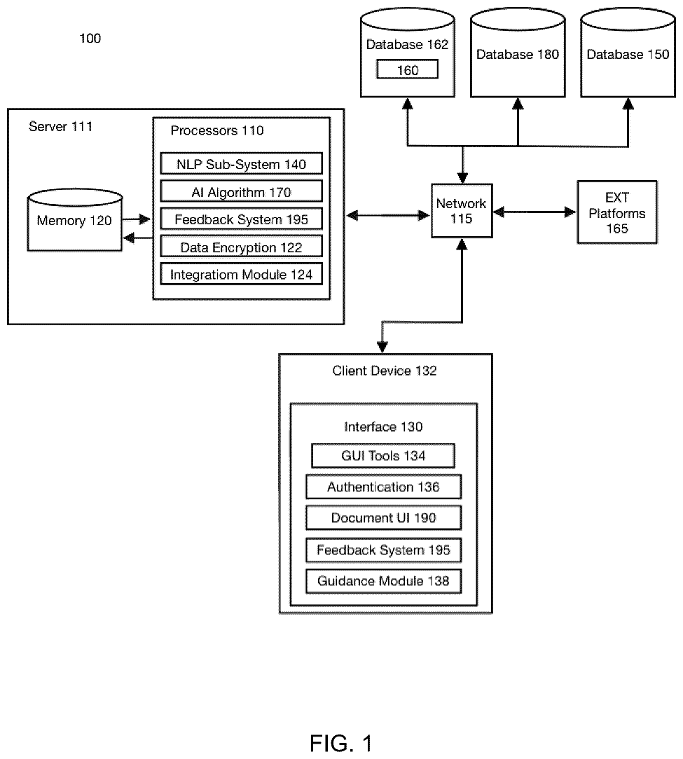

FIG. 1 is a system block diagram illustrating an intelligent legal document generation and review system 100. The system 100 comprises one or more processors 110 operatively coupled to a memory 120 storing instructions, wherein said processors 110 and memory 120 are disposed in a server 111 connected to a network 115. In one embodiment, when the instructions are executed by the processor(s) 110, they cause the processor(s) 110 to perform the various functions and operations of the system 100.

In the illustrated embodiment, the system 100 provides a user interface 130 configured to receive user input data related to a legal matter. As shown in FIG. 1, the user interface 130 is provided on a client device 132 coupled to the network 115, thereby allowing communication between the client device 132 and the server 111. In one embodiment, the user interface 130 includes a graphical user interface (GUI) that displays data input prompt tools, such as, by way of example and not limitation, text fields, drop-down menus, checkboxes, and buttons, for the user to input the relevant data. Optionally, the user interface 130 may also include file and information upload GUI tools 134 configured to allow users to upload probate-related files and information pertinent to their legal matter. In another embodiment, to ensure security, the user interface 130 includes a user credentials and authentication system 136 configured to validate the identity of users attempting to retrieve previously generated legal documents.

As illustrated in FIG. 1, the system 100 includes a natural language processing (NLP) subsystem 140 configured to extract relevant information from the user input data received via the user interface 130. In one embodiment, the NLP subsystem 140, implemented by the processors 110 and memory 120, analyzes the user input data using techniques including but not limited to tokenization, part-of-speech tagging, named entity recognition, and semantic parsing to understand the content and extract essential details. In the illustrated embodiment, based on the extracted details, the NLP subsystem 140 can identify the applicable jurisdiction and corresponding probate laws and regulations that are relevant to the user's legal matter.

The system 100 also comprises a legal rules and regulations database 150 configured to store applicable rules and regulations for various jurisdictions. In one embodiment, this comprehensive database 150 contains probate laws, individual state probate regulations, and other relevant legal information. As depicted in FIG. 1, the legal rules and regulations database 150 is coupled to the server 111 via the network 115, thereby enabling the NLP subsystem 140 to query this database 150 to retrieve the specific rules and regulations that apply to the user's legal matter based on the identified jurisdiction.

In another embodiment, to assist in generating legal documents, the system 100 stores a plurality of predefined templates 160 for different types of legal documents. As shown in FIG. 1, these templates 160 are disposed in a template repository 162, which is connected to the server 111 via the network 115. In one embodiment, the templates 160 serve as the starting point for creating customized legal documents and include placeholders and variables that can be populated with case-specific information.

The core of the system 100 is an artificial intelligence (AI) algorithm 170 configured to leverage the extracted information, applicable rules and regulations, and predefined templates to generate customized legal documents. In the illustrated embodiment, the AI algorithm 170, implemented by the processors 110 and memory 120, retrieves a relevant predefined template 160 from the template repository 162 based on the user input data and extracted information. It then populates the placeholders and variables in the template with the extracted information to create a customized legal document tailored to the user's specific legal matter. In one embodiment, the AI algorithm 170 is trained on extensive datasets related to probate laws, cases, examples, and regulations to ensure the accuracy and validity of the generated documents.

In one embodiment, the AI algorithm 170 for generating the initial customized legal document is implemented using a combination of natural language processing (NLP), rule-based systems, and template-based generation techniques. In the illustrated embodiment, the AI algorithm 170 is built using Python programming language and utilizes popular NLP libraries such as, by way of example and not limitation, spaCy or NLTK for extracting relevant information from the user input data. In one embodiment, the extracted information, including but not limited to the applicable jurisdiction, relevant parties, assets, and other case-specific details, is represented as structured data using JSON format. In another embodiment, the AI algorithm 170 then queries the legal rules and regulations database 150, to retrieve the specific rules and regulations that apply to the user's legal matter based on the identified jurisdiction. In the illustrated embodiment, the retrieved rules and regulations are encoded as a set of IF-THEN rules using a rule-based system framework such as Drools or Pyke. In one embodiment, the AI algorithm 170 selects the most appropriate predefined template 160 from the template repository 162 based on the type of legal matter, jurisdiction, and the presence of specific data points. In another embodiment, the template repository 162 is implemented using a version-controlled file system such as Git, and the templates are stored in a structured format such as XML or JSON. In the illustrated embodiment, the selected template is then populated with the extracted information using a template engine such as Jinja2 or Pug, replacing placeholders and variables with case-specific data. In one embodiment, the populated template undergoes initial validation against the encoded rules and regulations to ensure compliance with legal requirements. In the illustrated embodiment, the resulting customized legal document is then stored in the generated document repository 180, which is implemented using a secure and scalable cloud storage service such as Amazon S3 or Google Cloud Storage, with appropriate encryption and access controls in place.

As depicted in FIG. 1, the generated customized legal documents are stored in a generated document repository 180. In one embodiment, this repository 180 may be implemented as a local database management system, a cloud database associated with an individual user, or a common cloud database that employs encryption and permission-based access control to ensure data privacy and security. As shown in FIG. 1, the generated document repository 180 is coupled to the server 111 via the network 115.

In the illustrated embodiment, users can access and retrieve their customized legal documents through a document retrieval interface tool 190 provided by the system 100. In one embodiment, this tool 190, accessible through the user interface 130 on the client device 132, allows users to submit requests to retrieve their documents, authenticates their identity using the user credentials authentication system 136, and enables them to access the documents from the generated document repository 180 upon successful authentication.

In another embodiment, to ensure the quality and accuracy of the generated legal documents, the system 100 includes an attorney feedback loop system 195 implemented by the one or more processors 110 and memory 120. In the illustrated embodiment, this system 195 allows attorneys to review the customized documents and provide feedback and proposed revisions. In one embodiment, the AI algorithm 170 engages in a collaborative document revision process with the attorneys, analyzing their feedback, updating the documents based on the proposed revisions, and iteratively refining the documents through multiple rounds of feedback and updates. In another embodiment, the attorney feedback is also used to retrain the AI algorithm 170, allowing it to learn from the feedback and improve its performance over time.

As illustrated in FIG. 1, the system 100 incorporates several additional features to enhance its functionality and usability. In one embodiment, it includes a data encryption module 122 configured to encrypt user input data, extracted information, and generated documents to ensure data privacy and compliance with legal and ethical requirements. In another embodiment, the attorney feedback loop system 195 prompts attorneys to provide explanations for their suggested changes, which are stored along with the corresponding document templates and training data to improve the AI algorithm's learning process.

In the illustrated embodiment, the user interface 130 includes a guidance module 138 configured to provide explanations of legal terminology, present relevant legal resources and information to users, and offer support and assistance throughout their interaction with the system and completion of the probate process. Additionally, an integration module 124 enables the system 100 to integrate with external document management platforms 165, thereby allowing seamless transfer of generated documents for efficient storage, organization, and retrieval.

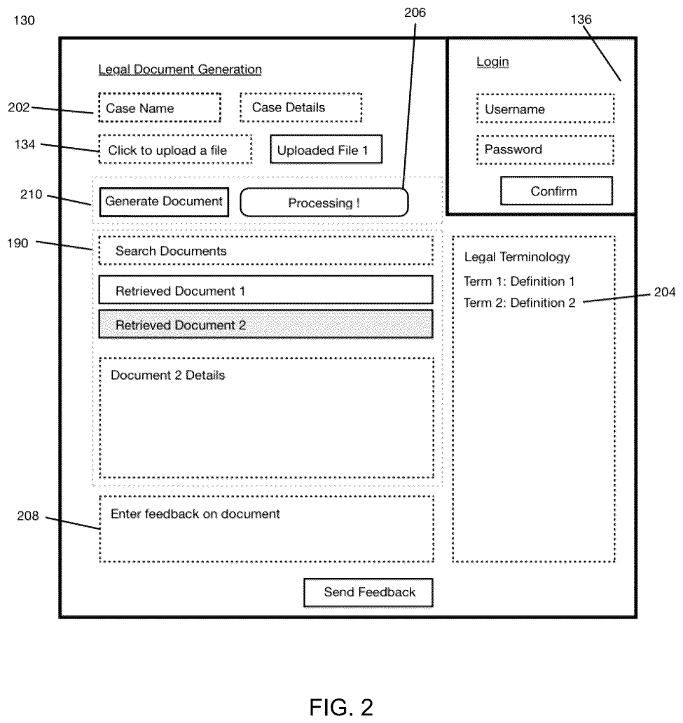

FIG. 2 illustrates the user interface 130 of the intelligent legal document generation and review system. The user interface 130 is a graphical user interface (GUI) provided on a client device 132, allowing users to interact with the system and input data related to their legal matter. In one embodiment, the user interface 130 comprises several key components that enable users to provide information, upload files, authenticate their identity, generate legal documents, and retrieve generated documents.

As shown in FIG. 2, the main components of the user interface 130 include Data Input Prompt Tools 202, wherein the user interface 130 presents a variety of data input prompt tools 202, such as text fields, drop-down menus, checkboxes, and buttons. These tools allow users to input relevant information about their legal matter, such as personal details, case-specific information, and preferences for document generation. The data input prompt tools 202 are designed to be intuitive and user-friendly, thereby guiding users through the process of providing the necessary information.

In another embodiment, the user interface 130 comprises File and Information Upload GUI Tools 134 that enable users to upload probate-related files and information pertinent to their legal matter. These tools provide a seamless way for users to attach relevant documents, such as will, trust agreements, and other legal paperwork, to their case, wherein the uploaded files are securely transmitted to the system for processing and integration into the document generation process.

To ensure the security and privacy of user information and generated documents, the user interface 130 incorporates a User Credentials and Authentication System 136. This system prompts users to create an account and provide their credentials, such as a username and password, to access the system, wherein the authentication process verifies the user's identity and grants access to their personalized dashboard and previously generated documents.

Once users have provided the necessary information and uploaded relevant files, they can initiate the document generation process through the Document Generation Interface 210. As illustrated in FIG. 2, this interface includes a prominent “Generate Document” button that users can click to submit their request. Optionally, the document generation interface 210 may also display a summary of the provided information and allow users to review and confirm the details before proceeding with the generation process.

According to an embodiment, the user interface 130 includes a Legal Terminology Explanation Module 204 that provides users with explanations and definitions of legal terms and concepts encountered throughout the document generation process. This module helps users better understand the legal language, thereby ensuring they can make informed decisions while inputting information and reviewing generated documents.

The user interface 130 features a Progress Tracking and Status Display 206 that keeps users informed about the progress of their document generation request. As depicted in FIG. 2, this display provides real-time updates on the status of the request, such as “Processing,” “Generating Document,” “Ready for Review,” and “Complete,” wherein users can easily track the progress of their request and know when their documents are ready for retrieval.

Once the legal documents have been generated and finalized, users can access them through the Document Retrieval Interface Tool 190. This tool allows users to view, download, and print their customized legal documents, wherein the document retrieval interface tool 190 is integrated with the user credentials and authentication system 136 to ensure that only authorized users can access their documents.

In one embodiment, the user interface 130 includes a Feedback and Support System 208 that allows users to provide feedback, ask questions, and seek assistance throughout their interaction with the system. Users can submit feedback on the generated documents, request clarifications on legal matters, and receive support from the system's customer support team, thereby helping ensure a positive user experience and providing users with the necessary guidance and assistance.

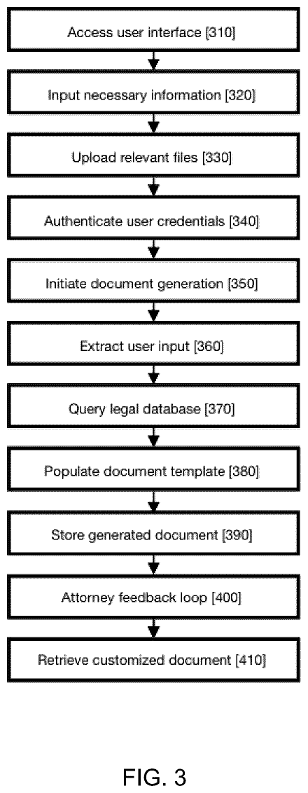

FIG. 3 illustrates a flow diagram 300 depicting the steps involved in using the intelligent legal document generation and review system 100. The flow diagram 300 outlines the process from user input to document retrieval and incorporates the key components and features of the system.

In one embodiment, the process begins with step 310, wherein a user accesses the user interface 130 provided on the client device 132. The user interface 130 presents the user with data input prompt tools 202, such as text fields, drop-down menus, checkboxes, and buttons, to gather relevant information about their legal matter.

In step 320, the user inputs the necessary information using the data input prompt tools 202. This information may include personal details, case-specific information, and preferences for document generation. The user interface 130 guides the user through the input process, thereby ensuring that all required information is provided.

Step 330 involves the user uploading probate-related files and information pertinent to their legal matter using the file and information upload GUI tools 134. These tools allow the user to attach relevant documents, such as wills, trust agreements, and other legal paperwork, to their case.

As shown in FIG. 3, step 340 involves the user credentials and authentication system 136 prompting the user to create an account and provide their credentials, such as a username and password. This step ensures the security and privacy of user information and generated documents.

Once the user has provided the necessary information and uploaded relevant files, step 350 involves initiating the document generation process through the document generation interface 210. The user clicks the “Generate Document” button to submit their request, thereby triggering the backend processing of the system 100.

In another embodiment, step 360 involves the natural language processing (NLP) subsystem 140 extracting relevant information from the user input data. The NLP subsystem 140 analyzes the user input using techniques such as tokenization, part-of-speech tagging, named entity recognition, and semantic parsing to understand the content and extract essential details.

Step 370 involves the NLP subsystem 140 querying the legal rules and regulations database 150 to retrieve the specific rules and regulations that apply to the user's legal matter based on the identified jurisdiction. The database 150 contains probate laws, individual state probate regulations, and other relevant legal information.

In step 380, the artificial intelligence (AI) algorithm 170 retrieves a relevant predefined template 160 from the template repository 162 based on the user input data and extracted information. The AI algorithm 170 then populates the placeholders and variables in the template with the extracted information to create a customized legal document tailored to the user's specific legal matter.

Step 390 involves storing the generated customized legal document in the generated document repository 180. The repository 180 securely stores the document and employs encryption and permission-based access control to ensure data privacy and security.

According to an embodiment, step 400 involves the attorney feedback loop system 195 allowing attorneys to review the customized documents and provide feedback and proposed revisions. The AI algorithm 170 engages in a collaborative document revision process with the attorneys, analyzing their feedback, updating the documents based on the proposed revisions, and iteratively refining the documents through multiple rounds of feedback and updates.

Finally, as depicted in FIG. 3, step 410 involves the user accessing and retrieving their customized legal documents through the document retrieval interface tool 190. The user submits a request to retrieve their documents, and the system authenticates their identity using the user credentials authentication system 136. Upon successful authentication, the user can access and download their documents from the generated document repository 180.

Throughout the process, the user interface 130 provides additional features to enhance the user experience. The legal terminology explanation module 204 offers explanations of legal terms, the progress tracking and status display 206 keeps users informed about the progress of their document generation request, and the feedback and support system 208 allows users to provide feedback and seek assistance.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. An intelligent legal document generation and review system, comprising:
one or more processors operatively coupled to a memory storing instructions that, when executed by the one or more processors, cause the one or more processors to:
provide a user interface configured to receive user input data related to a legal matter, wherein the user interface includes a graphical user interface displaying a data input prompt for a user to input the user input data;
execute a natural language processing subsystem configured to extract relevant information from the user input data;
access a legal rules and regulations database storing applicable rules and regulations for a plurality of jurisdictions;
store a plurality of predefined templates of legal documents;
execute an artificial intelligence algorithm configured to:
retrieve a relevant predefined template from the plurality of predefined templates based on the user input data and the extracted relevant information,
populate the retrieved predefined template with the extracted relevant information to generate a customized legal document, and
store the customized legal document in a generated document repository;
provide a document retrieval interface tool configured to enable the user to retrieve the customized legal document from the generated document repository; and
execute an attorney feedback loop system configured to receive attorney feedback on the customized legal document and provide the attorney feedback to the artificial intelligence algorithm to improve document generation;
wherein the artificial intelligence algorithm is further configured to engage in a collaborative document revision process with an attorney to revise and finalize the customized legal document based on the attorney feedback.

2. The system of claim 1, wherein the artificial intelligence algorithm is trained on datasets related to probate laws, probate cases, probate examples, individual state probate regulations, and legal document templates.

3. The system of claim 1, wherein the user interface further includes:
a set of file and information upload graphical user interface tools for users to upload relevant probate-related files and information; and
a user credentials and authentication system to validate the identity of users retrieving previously generated legal documents.

4. The system of claim 1, wherein the natural language processing subsystem is configured to:
analyze the user input data to understand the content and extract essential details; and
identify the applicable jurisdiction and corresponding probate laws and regulations based on the extracted details.

5. The system of claim 1, wherein the generated document repository is selected from the group consisting of:
a local database management system associated with an individual user;
a cloud database associated with an individual user; and
a common cloud database employing encryption and permissions-based access control.

6. The system of claim 1, wherein the artificial intelligence algorithm is further configured to:
automatically incorporate the attorney feedback to retrain itself and update the predefined templates; and
engage in the collaborative document revision process by accepting attorney revisions and making corresponding changes to the customized legal document.

7. The system of claim 1, further comprising a data encryption module configured to encrypt the user input data, extracted relevant information, and generated customized legal documents to ensure data privacy and compliance with legal and ethical requirements.

8. The system of claim 1, wherein the attorney feedback loop system is further configured to:
prompt attorneys to provide explanations for their suggested changes; and
store the explanations in association with the corresponding document templates and training data for the artificial intelligence algorithm.

9. The system of claim 1, wherein the user interface further includes a guidance module configured to:
provide explanations of legal terminology used in the user interface and generated documents;
present relevant legal resources and information to users; and
offer support and assistance to users throughout their interaction with the system and completion of the probate process.

10. The system of claim 1, further comprising an integration module configured to integrate the system with external document management platforms, wherein the generated customized legal documents are automatically transferred to the external platforms for efficient storage, organization, and retrieval.

11. A method for generating and reviewing legal documents using an intelligent system, comprising:
storing, in a memory, instructions for executing the method;
executing, by one or more processors operatively coupled to the memory, the instructions to perform the steps of:
1. receiving, via a user interface, user input data related to a legal matter;
2. extracting, using a natural language processing subsystem, relevant information from the user input data;
3. querying a legal rules and regulations database to retrieve applicable rules and regulations for a jurisdiction associated with the legal matter;
4. selecting a predefined template from a plurality of predefined templates of legal documents based on the user input data, the extracted relevant information, and the retrieved applicable rules and regulations;
5. populating, using an artificial intelligence algorithm, the selected predefined template with the extracted relevant information to generate a customized legal document;
6. storing the customized legal document in a generated document repository;
7. providing, via a document retrieval interface tool, access to the customized legal document to the user;
8. receiving, through an attorney feedback loop system, attorney feedback on the customized legal document;
9. engaging, by the artificial intelligence algorithm, in a collaborative document revision process with an attorney to revise the customized legal document based on the attorney feedback; and
delivering, via a document delivery system, a finalized version of the customized legal document to the user

12. The method of claim 1, further comprising providing, via the user interface, explanations of legal terms, access to resources, and assistance with questions or concerns that arise during the document generation or legal matter process.

13. The method of claim 1, wherein the user interface comprises a graphical user interface (GUI) displaying data input prompt tools for the user to input the user input data.

14. The method of claim 1, wherein the legal rules and regulations database is a comprehensive database storing applicable rules and regulations for a plurality of jurisdictions.

15. The method of claim 1, wherein selecting the predefined template comprises retrieving the predefined template from a plurality of predefined templates of various legal documents stored in a template repository.

16. The method of claim 1, wherein storing the customized legal document in the generated document repository comprises securely storing the customized legal document in an encrypted database with permission-based access control.

17. The method of claim 1, wherein providing access to the customized legal document comprises:
receiving, via the document retrieval interface tool, a user request to retrieve the customized legal document;
authenticating the user's identity using a user credentials authentication system; and
upon successful authentication, enabling the user to access the customized legal document from the generated document repository.

18. The method of claim 1, wherein engaging in the collaborative document revision process comprises:
receiving, from the attorney feedback loop system, proposed revisions to the customized legal document;
updating, by the artificial intelligence algorithm, the customized legal document based on the proposed revisions; and
iteratively refining the customized legal document through multiple rounds of attorney feedback and artificial intelligence updates.

19. The method of claim 1, further comprising:
analyzing the attorney feedback by the artificial intelligence algorithm;
identifying areas for improvement in the legal document generation process based on the analysis; and
retraining the artificial intelligence algorithm based on the attorney feedback to improve accuracy and effectiveness of future legal document generation.

20. The method of claim 1, wherein delivering the finalized version of the customized legal document comprises transmitting, by the document delivery system, the finalized customized legal document to the user via a secure electronic communication channel.
